(19) United States
(12) Patent Application Publication
(10) Pub. No.: US 2018/0318639 A1
(43) Pub. Date: Nov. 8, 2018

(54) SMART LEG MOVEMENT STIMULATOR DEVICE

(71) Applicant: CTL CO., LTD., Seoul (KR)

(72) Inventor: Julee KIM, Seoul (KR)

(73) Assignee: CTL CO., LTD., Seoul (KR)

(21) Appl. No.: 15/771,045

(22) PCT Filed: Aug. 5, 2016
(86) PCT No.: PCT/KR2016/008661

§ 371 Date: Apr. 25, 2018

(30) Foreign Application Priority Data
Nov. 9, 2015 (KR) 10-2015-0156312

(51) Int. Cl. A63B 22/20; A61H 9/00; A63B 24/00; A63B 21/00; A63B 22/00; A63B 21/068

(52) U.S. Cl. CPC A63B 22/201; A63B 2022/185; A63B 24/0087; A63B 24/0062; A63B 21/4034; A63B 22/0017; A63B 21/068; A63B 22/0046; A61H 2201/0103; A61H 2201/0192; A61H 2201/1261; A61H 2201/1642; A61H 2201/1661; A61H 2201/1666; A61H 2201/5071; A63B 2022/0038; A61H 9/0085

(57) ABSTRACT

A leg movement stimulator device for use while sitting. Other embodiments of leg movement stimulator device include leg gliding mechanism (12) to allow simple exercise for user while simultaneously performing other sedentary activities, and extension function (13) for width adjustment, and a diversified movement mechanism (22), (22a) for joints and small muscles stimulation, and data generating and communicating mechanism (30), (30a), (31), (33) with user's smart electronic devices is also available for user's convenience in tracking and monitoring the movement activities. Other embodiments include chair fixing mechanism (14), (14a) to hold the device from moving, and stepper mechanism (11a), (11b), (22a′), (22b) and varied track direction (12c) for diverse exercise of the user.

### TECHNICAL FIELD

This application generally relates to exercise and therapeutic device which communicates with smart electronic devices, specifically to a leg movement stimulating device with alternative leg exercise and ankle angle variations for use while being seated.

### BACKGROUND ART

Numerous medical studies and news articles have reported how the extended sedentary lifestyle has become a serious threat to our health in general, especially closely connected with death risk increase, diverse cancer risk increase, diabetes risk, blood circulatory difficulties and obesity. To prevent such negative health influence, it has become popular to stand instead of sitting at the office or during meeting time. However, it is not the sitting itself that is bad, but the prolonged immobile posture that is maintained while sitting, and continued standing also has its own side effects such as joint fatigue, varicose veins and leg swellings, as some doctors mention.

Numerous exercise devices which provide exercise function while sitting at an office chair or simultaneous performance of physical exercises and office work have been introduced, usually by attachment of the device to either a desk or a chair, or a seat with a built-in exercising function. The following examples are of typical prior art to this field of endeavor.

U.S. Pat. No:

| | | |
|---|---|---|
| Des. 158,675 | Longfellow | Jan. 13, 1949 |
| 3,751,033 | Rosenthal | Aug. 7, 1973 |
| 3,968,963 | Sileo | Jul. 13, 1976 |
| 4,601,464 | Mousel | Jul. 22, 1986 |
| 4,913,423 | Farran | Apr. 3, 1990 |
| 5,044,633 | Rice | Jan. 9, 1991 |
| 5,108,092 | Hurst | Apr. 28, 1992 |
| 5,599,260 | Rovinsky | Feb. 4, 1997 |
| 5,690,594 | Mankovitz | Nov. 25, 1997 |
| 5,807,212 | Nelson | Dec. 4, 1996 |
| 5,833,575 | Holslag | Nov. 10, 1998 |
| 6,056,675 | Aruin | May 2, 2000 |
| 6,099,445 | Rovinsky | Feb. 4, 1998 |
| 6,866,618B2 | Rusinak-Connors | Mar. 15, 2005 |
| *218,512,210 | Shauli | May 11, 2008 |
| 9,813,059 | Willis | Sep. 26, 2002 |
| 10,698,295 | Andre | Jul. 22, 2004 |
| 10,950,931 | Neff | Mar. 10, 2005 |
| ll,766,299 | Bowser | 0ct. 18, 2007 |
| ll,797,090 | Oren; Reisman | Jan. 3, 2008 |

### DISCLOSURE

### Technical Problem

Most prior art describe devices that have rather limited range of movement, exercise capacity, or is applicable only for a limited type of chair or are too bulky to use under conventional office desks. Moreover, considering that the majority users would use these devices in the office where the furniture belong to the company, easy installation and removal without damaging the office furniture is important while requiring small space for diverse office circumstances. Prior arts which satisfy such requirements either have weak resistance on the pedal bearing or require the user to replace the whole chair itself, as the chair has built-in exercise system. Otherwise, some prior art describe devices that may be used in offices but require additional time for exercise, instead of simultaneous exercise with conventional office work such as computer or phone conversation.

Health related studies show that exercising the lower body, such as thighs where large amount of muscles are formed, burns more calories while it also prevents deep-vein thrombosis, varicose vein and other blood circulatory troubles, thus is especially recommended for people with extended stationary or sedentary work. Efforts to solve such exercise deficiency issue with more efficient and effective lower body movements for office workers have lead to the following prior art examples.

U.S. Pat. No.:

| | | |
|---|---|---|
| 7,648,447B2 | Andre | 0ct. 31, 2003 |
| D728,707 | SColburn | Nov. 29, 2013 |

Although above-noted prior art propose most compatible exercise with existing office furniture, few concerns are raised with the cycling system, as when one pedal is low, the opposite one rises, elevating the knee level. This may lead to the knee hitting the desk, in case not enough desk height is secured. Chair-holding system could also limit the user's usual motions at the office, such as moving with the chair or swinging to another direction, since the chair-holding device is stationary to a fixed position.

### Technical Solution

Accordingly, an aspect of the present invention involves a compact device for promoting leg movements and pedals with various angle changes that allow stretching especially calves and ankles while being seated and doing other tasks simultaneously, and to connect the sensor collected data to users' smart electronic devices through communication module.

### Advantageous Effects

Advantages of this application of one or more aspects are to provide an easy movement of legs in multiple directions, maximizing muscle movements without damaging or replacing existing furniture, and to assist stretching diverse leg muscles by changing the angles of the ankle which simultaneously stimulates lower-body muscle movements. Other advantages of one or more aspects are to provide simple sliding movements which make it easier to move and use for prolonged period of time without getting tired, helping blood circulation and calorie burning. This application describes device which also comprises of sensors that sense collect the movement data, which communicates with the user's smart electronic devices to monitor and promote more movement, allowing activities such as, but not limited to, exercise goal setting, smart device controlling with feet movement, display user's activity history.

### DESCRIPTION OF DRAWINGS

In the drawings, closely related figures have the same number but different alphabetic suffixes.

FIG. 1 is a perspective view of the most preferred embodiment of the smart leg movement stimulator device.

FIG. 2 illustrates a top view of the leg movement stimulator device illustrated in FIG. 1.

FIG. 3 is a side view of the smart leg movement stimulator device illustrated in FIG. 1.

FIG. 4 is a front view of smart leg movement stimulator device illustrating main body connection with a width control method of FIG. 1.

FIG. 5A-5C illustrates exploded views of the portions in the most preferred embodiment of pedal angle flexing method of smart leg movement stimulator device.

FIG. 6 presents examples of potential operation applications of the smart leg movement stimulator device in FIG. 1.

FIG. 7 illustrates an example of potential method of diverse sensor operation applications of the smart leg movement stimulator device in FIG. 1.

FIG. 8 presents an example of a process map for connecting the sensor generated data from the smart leg movement stimulator device with smart devices.

FIG. 9A-9B illustrate one of many examples of smart leg movement stimulator device with a chair leg fixing base.

FIG. 10 is an illustration of another one of many examples of smart leg movement stimulator device with an altered slope surface.

FIG. 11A-11B present examples of many potential methods of stepper operation applications of the smart leg movement stimulator device in FIG. 1.

FIG. 12 is a perspective view of one of many examples of smart leg movement stimulator device in FIG. 1, with multiple direction movement operation method.

FIG. 13 illustrates one of many examples of potential method of smart leg movement stimulator device in FIG. 1, with multiple direction movement operation method.

FIG. 14 presents an example of potential operation application of the smart leg movement stimulator device in FIG. 13 operating a smart device controller.

### BEST MODE

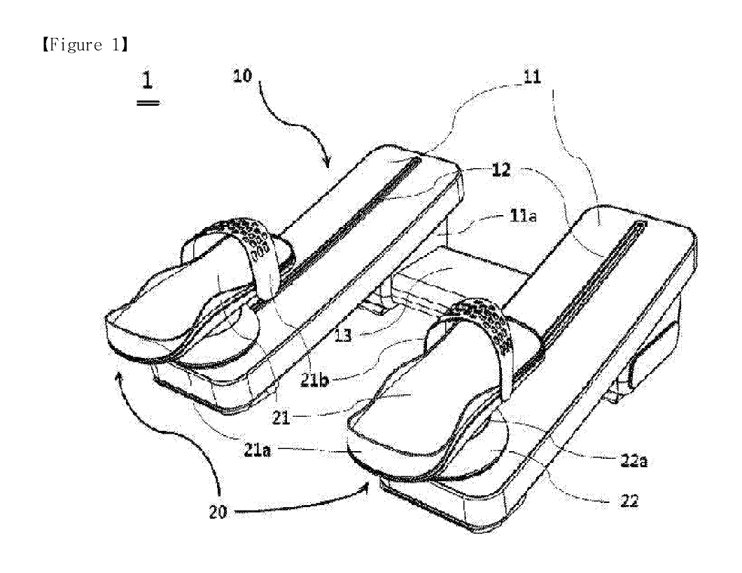

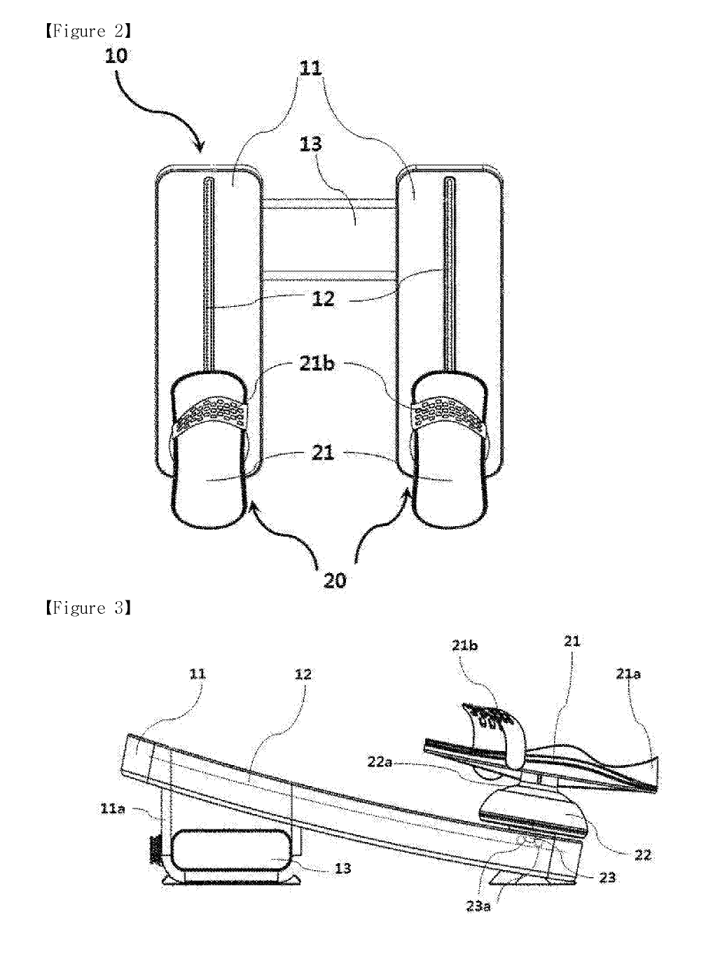

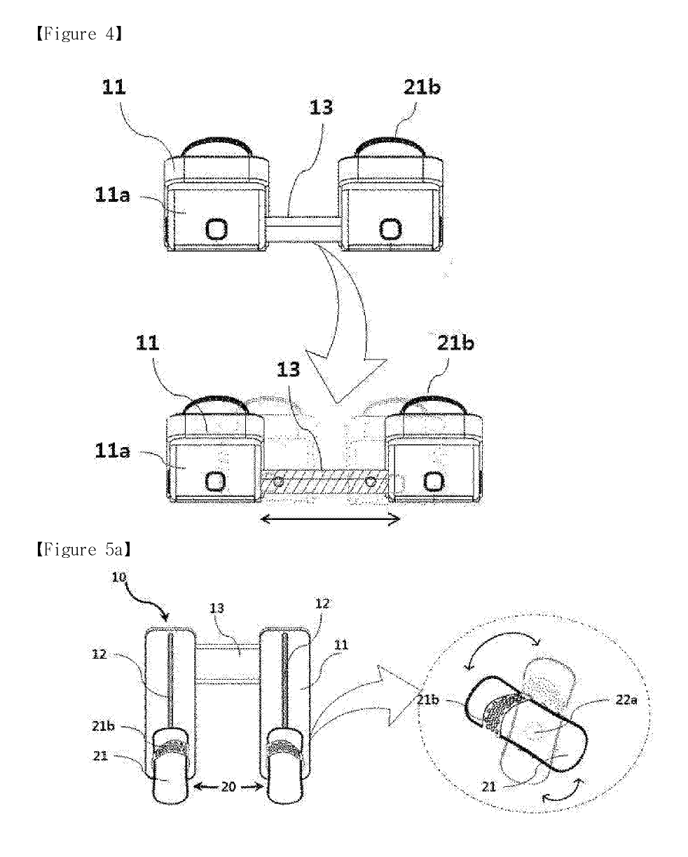

Most preferred embodiment of a smart leg movement stimulator device (1) is shown in FIGS. 1-3. The device is composed of main body composition (10), pedal composition (20), sensors (31) and micro controller unit (MCU) processor (33). The main body composition (10) is compact for leg movement stimulation while being seated with any conventional chair or seat, including but not limited to office chairs, sofas and benches. The main body composition (10) includes a main body surface (11), two main body height supports (11a), two pedal tracks (12) and a main body connection body (13). The said main body connection body (13) connects the two main body height supports (11a) which allow width control as illustrated in FIG. 4.

The main body composition (10) serves as the base to locate the pedal tracks (12) which facilitate the movement of the pedal composition (20), and provide slope angle for movement resistance force using gravity among other forces. Although not illustrated, other sliding resistance force may include using, but not be limited to, springs, magnetic force, friction, liquid and air.

The two pedal compositions (20) may each be composed of pedal main surface (21), pedal heel slip lock (21a), pedal size adjustment composition (21b), pedal base (22), pedal connector lever (22a), pedal track connector (23) and one or more pedal track roller (23a).

The main body connection body (13) may be composed of an attach-and-detach method from the main body height support (11a) on both ends to minimize the smart leg movement stimulator device's volume when moving, packing or fitting under small space, preferably with width adjustment function for user's convenience as shown in FIG. 4.

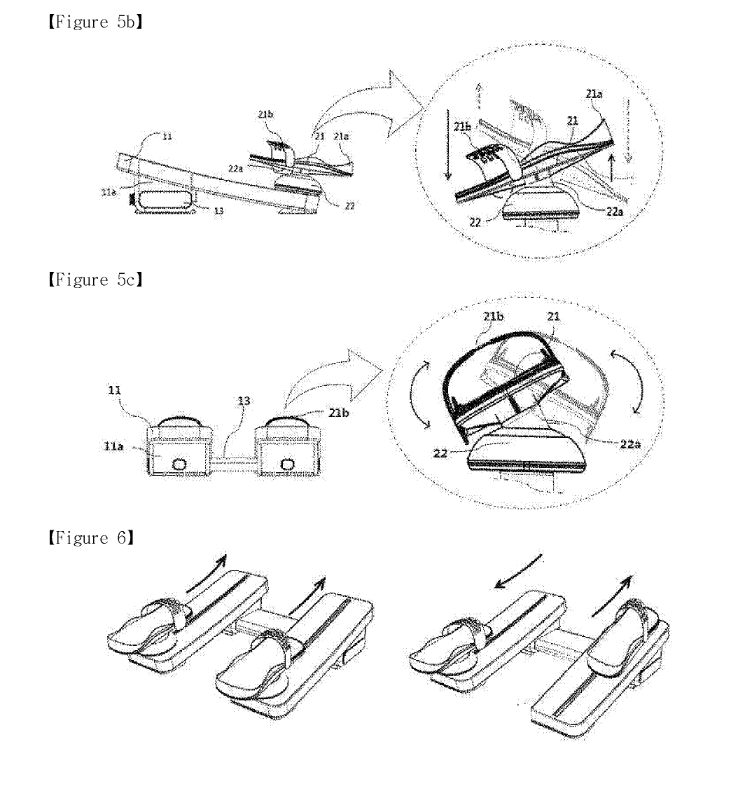

As illustrated in FIGS. 5A-5C, the pedal composition (20) of each side is composed of a pivotal pedal base (22) and a pedal connector lever (22a) connecting with pedal main surface (21), preferably with direction variations. The pedal base (22) and pedal connector lever (22a) may sway to inward and outward sides as shown in FIG. 5A, and swing in multiple directions including, but not limited to, front and back and left and right, similar to a joystick as shown in FIGS. 5B and 5C. The direction variation functions may allow muscle stretching, especially on calves, and help stimulate small muscles connected to ankle movements. Small muscle movements are helpful to prevent pains deriving from muscle stiffening due to rigid posture.

FIG. 6 illustrates one of many examples of preferred use of the smart leg movement stimulator device (1), as both pedal composition (20) may be pushed-and-pulled simultaneously or alternatively moved in turns. Such movements are beneficial for the leg muscles to be in motion and promote blood circulation while burning calories.

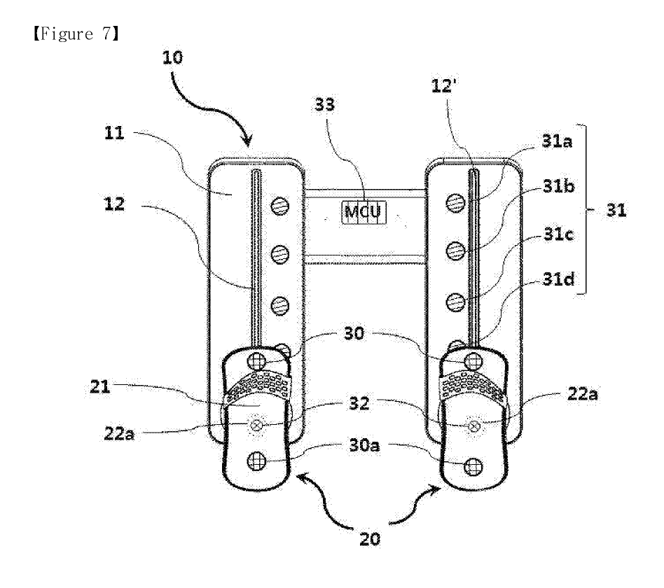

The sensors may be located in various locations of the smart leg movement stimulator device (1) as shown in FIG. 7. The front pedal sensor (30) and pedal heel sensor (30a) may be located at the front and rear part of the pedal main surface (21) of each pedal composition (20), preferably with direction and pressure sensing function. The distance sensors (31) may be located in various points of the main body composition (10) to measure the distance from the pedal location sensor (32). There may be multiple sensors, preferably four as illustrated in (31a)-(31d), which the generated sensor data are collected to micro controller unit (33) to provide the data through communication module to a smart device that the user may connect with, allowing to monitor information such as strength, stride length and stride time of each side. Such data may be used to calculate and presume the user's unbalanced posture and/or strength to improve and/or correct.

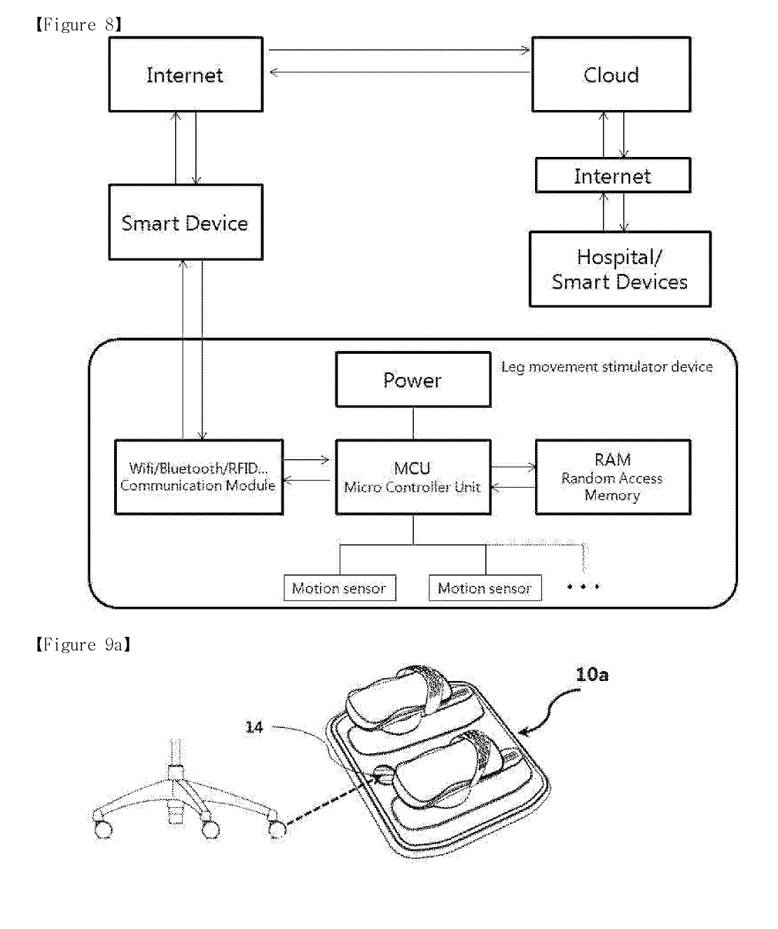

FIG. 8 illustrates an example of preferred process map for connecting the sensor generated data of the smart leg movement stimulator device (1) to smart devices including, but not limited to, smart phone, smart TV, smart watch, smart band, smart glasses, tablet PC and PC (personal computer). The generated data of sensors of FIG. 7, may use local and/or short-range communication network including, but not limited to, Bluetooth, Wifi, Zigbee, RFID and NFC to connect to the smart device which may transfer the data to cloud, hospitals or other smart devices. Such data may be used with diverse algorithms including, but not limited to, calculating the calories burnt, balancing of strengths, setting exercise goals, monitor activity trends, presume user's postures, and using as reference in mild movement therapies for clinics and/or hospitals.

FIGS. 9A-9B illustrate one of many examples of alternative smart leg movement stimulator device (1) with an alternative main body composition (10a) with preferable chair leg fixer base (14) or open chair leg fixer base (14a). The chair leg, preferably being a roller type, may be located in chair leg fixer base to prevent the smart leg movement stimulator device (1) from moving, while also holding the chair from moving due to leg movement.

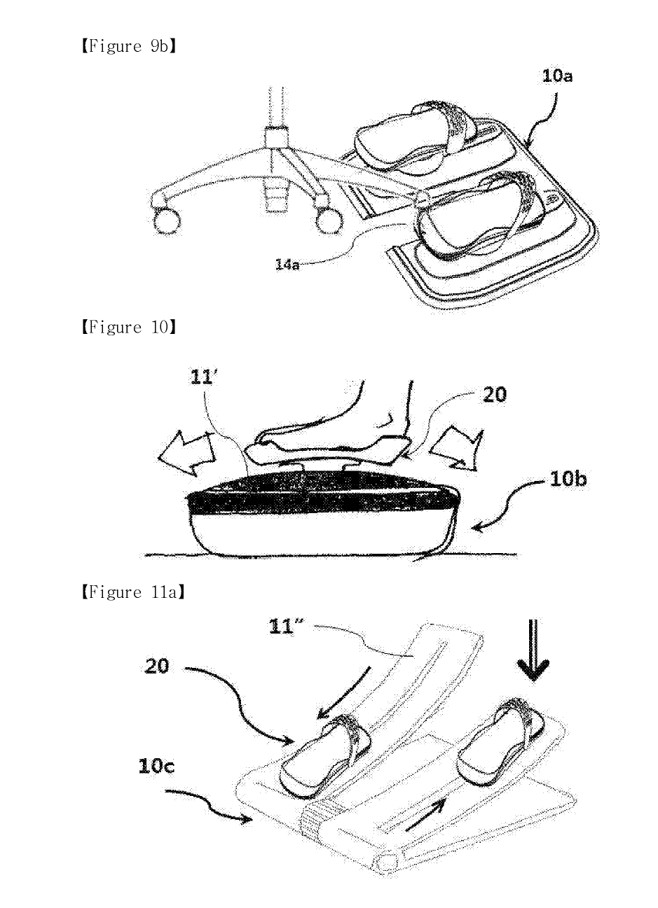

FIG. 10 shows an example of an alternative main body surface (11′) where the surface is convex as alternative convex body composition (10b), and allows a varied sliding movement, preferably using gravity force among others.

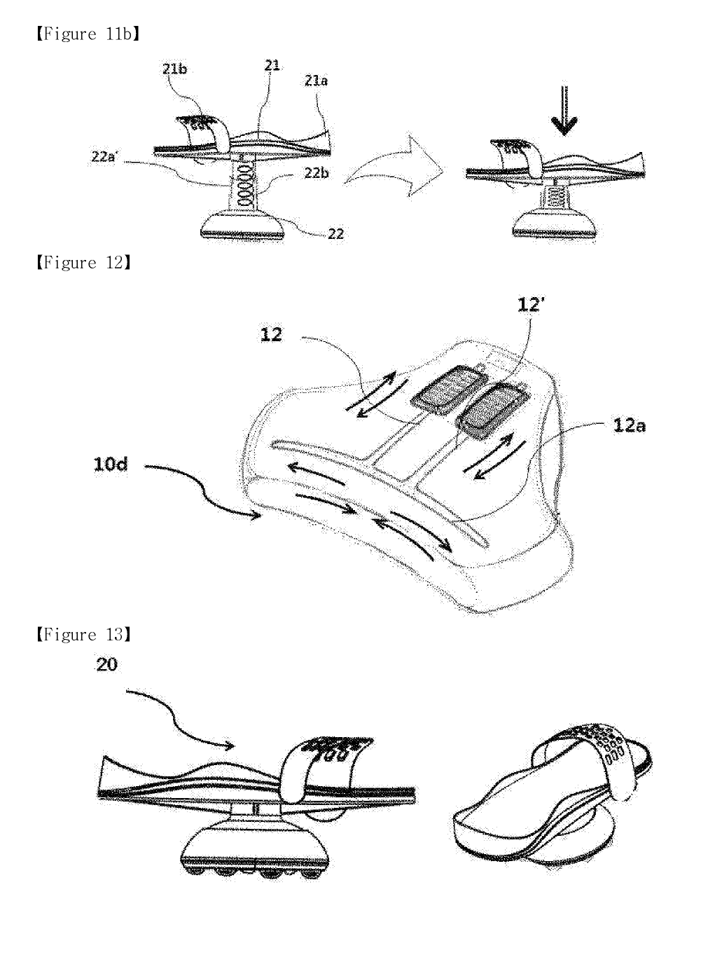

FIG. 11A-11B show preferable examples of stepping function using alternative step body composition (10c), where height of each sides of the alternative convex main body surface (11″) is varied depending on the pressure given to each pedal composition (20) due to the own material elasticity of the main alternative step body composition, preferably using, but not limited to polycarbonate or metal, and other altered pedal connector lever (22a′) including elastic force, may preferably include elastic spring (22b), and may be replaced with the other preferable elastic force, but not limited to, magnetic force, elastic band, liquid or and air. Though not illustrated, the pedal main surface (21) may preferably have a surface that could insert air or liquid where when the pressure is given at one point, the opposite side is expanded, allowing a light foot massage effect.

FIG. 12 shows one of many examples of alternative multiple track composition (10d) with multiple track directions available for diverse movement. Multiple pedal movement directions help stimulate different muscles of the legs and joints, and horizontal push-and-pull movements including, but not limited to, horizontal track (12a) are especially helpful for inner thigh exercise,

FIG. 13 illustrates an example of many alternative multiple track composition where the pedal base (22) includes rollers that allow free-direction movement on the floor. Advantages of this application of one or more aspects is that the pedal composition (20) may be independently used on the floor without main body composition (10). The pedal composition (20) of FIG. 13 may be composed of micro controller unit and communication module (33) and distance sensors (31) to send the generated data including, but not limited to, location, direction, pressure, counting, speed, to connected smart device.

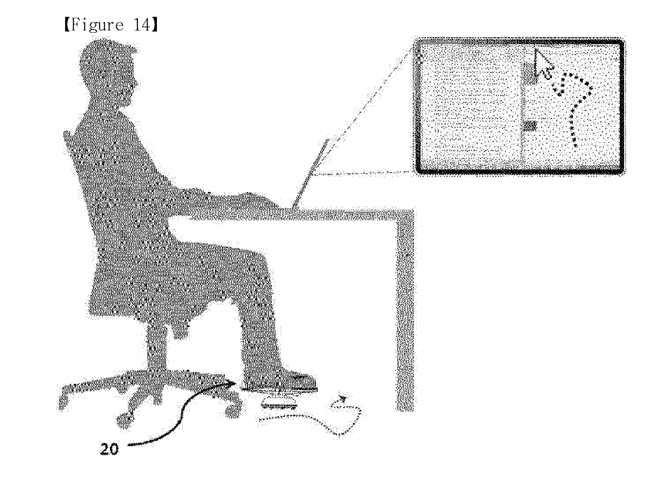

FIG. 14 shows one of many examples of preferred use of the smart leg movement stimulator device (1) of FIG. 13, as the pedal composition (20) may be used as a smart device controller, including, but not limited to, computer mouse, where the cursor is controlled with the leg movement or feet movement, allowing natural movements of lower body and stimulating the brain through said movements as the user does computer works.

1. A smart leg movement stimulator device comprising:
a. a main body composition having a pedal mechanism providing means to slide,
b. resistance means on said pedal mechanism, and
c. a control mechanism having sensors collecting movement data from said pedal mechanism and communicating said data with smart devices,
whereby said device allows substantial exercise of lower-body in limited space, and provide movement promotion with movement data displayed on smart devices.

2. The smart leg movement stimulator device of claim 1, further including:
a. a sloped surface mechanism of said main body composition for sliding said pedal mechanism,
b. a width control mechanism having a connection means on the said main body composition, and
whereby said sloped surface mechanism provides natural resistance for sliding, and the width control mechanism provide the user to adjust the said leg movement stimulator device to user's comfort.

3. The smart leg movement stimulator device of claim 1, wherein the main body composition includes means of height altering mechanism upon pressure that allow the user to use the said smart leg movement stimulator device for stepping exercise.

4. A pedal composition of smart leg movement stimulator device providing:
a. means of pivotal pedal mechanism of multidirectional pedal angles,
b. a direction variation mechanism of horizontal twist of the pedal,
whereby said pedal methods allow the user to diversify leg and ankle exercise.

5. The pedal composition of claim 4, further including
means of elastic mechanism providing vertical resistance on said pivotal pedal mechanism so that the users may diversify the exercise intensity upon pressing down the pedal composition.

6. The pedal composition of claim 4, wherein the pedal surface has means of inflating so that when pressure is given on one side, the opposite side changes in height and pressure to stimulate the foot sole.

7. The pedal composition of claim 4, further including pedal sliding means to freely move over conventional floor.

8. The pedal composition of claim 4, having means of sensors, micro controller unit and communication, to collect the sensor generated data for communicating with smart devices.

9. The smart leg movement stimulator device of claim 1, further including additional sensors for location and pressure, and the control mechanism collects the location and pressure data of the pedal composition, and communicates the collected data with smart devices.
